(19) United States
(12) Patent Application Publication
(10) Pub. No.: US 2003/0226968 A1
(43) Pub. Date: Dec. 11, 2003

(54) Apparatus and method for inputting data

(76) Inventor: Steve Montellese, Pittsburgh, PA (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/167,301

(22) Filed: Jun. 10, 2002

(51) Int. Cl. G01J 5/02

(52) U.S. Cl. 250/341.1

(57) ABSTRACT

An input device for detecting input with respect to a reference plane. The input device includes one or more light sensors positioned to sense light at an acute angle with respect to the reference plane and for generating a signal indicative of sensed light, and a circuit responsive to said light sensor for determining a position of an object with respect to the reference plane.

### FIELD OF THE INVENTION

The present invention is directed generally to an apparatus and method for inputting data. More particularly, the present invention is directed to an apparatus and method that uses sensed light to determine the position of an object.

### BACKGROUND OF THE INVENTION

Input devices are used in almost every aspect of everyday life, including computer keyboards and mice, automatic teller machines, vehicle controls, and countless other applications. Input devices, like most things, typically have a number of moving parts. A conventional keyboard, for example, has moveable keys that open and close electrical contacts. Moving parts, unfortunately, are likely to break or malfunction before other components, particularly solid state devices. Such malfunction or breakage is even more likely to occur in conditions that are dirty or dusty. Furthermore, input devices have become a limiting factor in the size of small electronic devices, such as laptop computers and personal organized. For example, to be efficient a keyboard input device must have keys that are spaced at least as far apart as the size of the user's finger tips. Such a large keyboard has become a limiting factor as electronic devices become smaller.

Some prior art devices have attempted to solve one or more of the above-mentioned problems. For example, touch screens can sense a user touching an image on the monitor. Such devices, however, typically require sensors and other devices in, on, or around the monitor. Furthermore, reducing the size of such an input device is limited to the size of the monitor.

Other prior art devices sense the position of a user's finger using light sensors. Those devices, however, often require light sensors to be located above and perpendicular to the keyboard, or other input device. As a result, they tend to be bulky and are not suited for use in small, hand-held devices.

Other prior art devices sense position of a user's finger with light sensors located on the surface to be monitored. In the case of a keyboard, for example, such devices typically require that sensors be located at the corners or other boundaries of the keyboard. As a result, they are bulky because the sensors must be spread out to be at least the same size as the keyboard. Such a device does not lend itself to use in a small, hand held device or in providing a full sized keyboard, or other input device.

As a result, the need exists for an input device that is large enough to be used efficiently, and which can be contained within a small package, such as an electronic device, like as a laptop computer or a personal organizer. The need also exists for an input device that is not susceptible to failure caused by particulate matter, such as dirt and dust.

### SUMMARY OF THE INVENTION

The present invention includes an input device for detecting input with respect to a reference plane. The input device includes a light sensor positioned to sense light at an acute angle with respect to the reference plane and for generating a signal indicative of sensed light, and a circuit responsive to said light sensor for determining a position of an object with respect to the reference plane. The portion of the object with respect to the reference plane can then be used to produce an input signal of the type that is now produced by a mechanical device. That input signal is input to an electronic device, such as a portable computer or a personal organizer.

The present invention also includes a method of determining an input. The method includes providing a source of light, sensing light at an acute angle with respect to a reference plane, generating at least one signal indicative of position of the object with respect to the reference plane.

The present invention overcomes deficiencies in the prior art by providing for an input device that is compact and that allows for a full sized keyboard or other input means to be provided. Unlike prior art devices that require sensors to be located directly above the area to be sensed or at the boundaries of the area to be sensed, the present invention allows the input device to be self contained and remote from the area to be sensed.

Those and other advantages and benefits of the present invention will become apparent from the description of the preferred embodiments hereinbelow.

### BRIEF DESCRIPTION OF THE DRAWINGS

For the present invention to be clearly understood and readily practiced, the present invention will be described in conjunction with the following-figures, wherein:

FIG. 1 is a block diagram illustrating an input device constructed in accordance with the present invention.

FIG. 2 is a top plan schematic view of the input device illustrating the orientation of the first and second sensors.

FIG. 3 is a schematic representation of a projector and a light source oriented in an input device constructed in accordance with the present invention.

FIG. 4 is a perspective view of an input device sensing a user's finger.

FIGS. 5-8 are graphical representations of light sensed by two dimensional matrix type sensors.

FIG. 9 is a combination side plan view and block diagram illustrating another embodiment of the present invention wherein the light source produces a plane of light adjacent to the input template.

FIG. 10 is a graphical representation of a two dimensional matrix type sensor illustrating how an image from a singe two dimensional matrix type sensor may be used to determine position of an object adjacent to an input template.

FIGS. 11 and 12 illustrate one dimensional array type sensors that may be used in place of the two dimensional matrix type sensor illustrated in FIG. 10.

FIG. 13 is a block diagram illustrating an alternative embodiment of the present invention including projection glasses, such as may be used in virtual reality applications, to provide the user with an image of an input template.

FIG. 14 illustrates an alternative embodiment wherein an index light source provides an index mark for aligning an input template.

FIG. 15 is a block diagram illustrating a method of detecting an input with respect to a reference plane.

FIG. 16 is a block diagram illustrating a method of calibrating the input device.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements. Those of ordinary skill in the art will recognize that other elements may be desirable and/or required in order to implement the present invention. However, because such elements are well known in the art, and because they do not facilitate a better understanding of the present invention, a discussion of such elements is not provided herein.

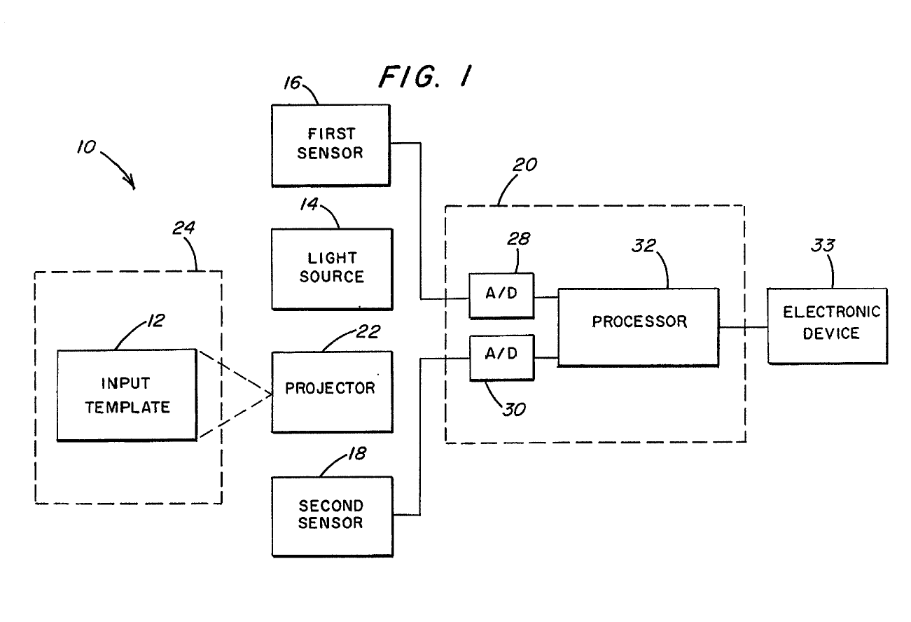

FIG. 1 is a block diagram illustrating an input device 10 constructed in accordance with the present invention. The input device 10 includes an input template 12, a light source 14, a first light sensor 16, a second light sensor 18, and a circuit 20.

The input template 12 facilitates using the input device 10 and may be an image of an input device, such as a keyboard or a pointer. The input template 12 may be a physical template, such as a surface with an image of an input device printed thereon. For example, the input template 12 may be a piece of paper or a piece of plastic with an image of a keyboard printed thereon. The input template 12 may also be formed from light projected onto a solid surface. For example, a projector 22 may project an image of the input template 12 onto a solid surface, such as a desktop. The projector 22 may be, for example, a slide projector or a laser projector. The projector 22 may also provide several different input templates 12, either simultaneously or individually. For example, a keyboard and pointer may initially be provided simultaneously. During other functions, however, the input template 12 may take other forms, such as a button panel, a keypad, and a CAD template. In addition, the projector 22 may provide custom input templates 12. The input template 12 may also be formed from other than a projector 22, such as being formed from a holographic image or from a spherical reflection. The input template 12 may even be eliminated, as described hereinbelow.

The input template 12 is located in a reference plane 24. The reference plane 24 is defined by the input device 10 and is used as a reference for determining input from a user. For example, if the input device 12 is acting as a keyboard, the reference 24 plane may be thought of as an imaginary keyboard. The user's motions are monitored with reference to the reference plane 24 to determine what keys on the keyboard are being selected. The reference plane 24 may be thought of as being further defined into keys on the keyboard, with each key having a position on the reference plane 24 so that motions from the user can be translated into characters selected from the keyboard.

The light source 14 provides light adjacent to the input template 12. The light source 14 may provide any of many types of light, including visible light, coherent light, ultraviolet light, and infrared light. The light source 14 may be an incandescent lamp, a fluorescent lamp, or a laser. The light source 14 need not be a mechanical part of the input device 10, because the input device 10 may utilize ambient light from the surroundings; or infrared light produced by a person's body. When the input device 10 is used on a top of a flat surface, the light source 14 will typically provide light above the input template 12. The input device 10, however, has many applications and it need not be used on top of a flat surface. For example, the input device 10 may be mounted vertically on a wall, such as an automatic teller machine, a control panel, or some other input device. In such embodiment, the light source 14 will provide light adjacent to the input template 12, and from the perspective of a user, the light source 14 provides light in front of the input template 12. Alternatively, if the input device 10 is mounted above the user, such as in the roof of an automobile or an airplane, the light source 14 will provide light adjacent to 15 and below the input template 12. In each of those embodiments, however, the light is provided adjacent to the input template 12.

The first and second light sensors 16, 18 are positioned to sense light at an acute angle with respect to the input template 12, and to generate signals indicative of the sensed light. The first and second light sensors 16, 18 may be any of many types of light sensors, and may include focusing and recording apparatus (i.e., a camera). For example, the first and second light sensors 16, 18 may be two dimensional matrix type light sensors and may also be one dimensional array type light sensors. Furthermore, the first and second light sensors 16, 18 may sense any of many types of light, such as visible light, coherent light, ultraviolet light, and infrared light. The first and second light sensors 16, 18 may also be selected or tuned to be particularly sensitive to a predetermined type of light, such as a particular frequency of light produced by the light source 14, or infrared light produced by a person's finger. As discussed hereinbelow, the input device 10 may also utilize only one of the first and second light sensors 16, 18 and, alternatively, may utilize more than two light sensors.

The circuit 20 is responsive to the first and second light sensors 16, 18 and determines a position of an object with respect to the reference plane 24. The circuit 20 may include analog-to-digital converters 28, 30 for converting analog signals from first and second light sensors 16, 18 into digital signals for use by a processor 32. The position of the object or objects with respect to the reference plane must be determined in three dimensions. That is, if one were to observe a keyboard from directly above using a two dimensional image, we could tell which key a finger was hovering over. This would not tell us whether or not the finger moved vertically to depress the particular key. If we observed a keyboard from a plane parallel to the table, we could see the vertical location of a finger and it's location on a single plane (x and y location) but not it's location in the z direction (distance away). Inasmuch, several methods exist for determination of the necessary information. The processor 32 may determine the position of an object adjacent to the input template 12 by using one or more of these techniques. The processor 32 may also apply image recognition techniques to distinguish between objects used to input data and background objects. Software for determining the position of an object and for image recognition is commercially available and may be obtained from Millennia 3, Inc., Allison Park, Pa. The circuit 20 may provide an output signal to an electronic device 33, such as a portable computer or a personal organizer. The output signal is indicative of input selected by the user.

There are several processing methods by which the position of an object may be determined. These include triangulation using structures light, binocular disparity, rangefinding and the use of fuzzy logic.

To sense positional attributes of objects with triangulation using structured light, the, the X and Z locations of the finger are calculated using triangulation of the light reflected off of the finger(s). The Y position, (i.e., the vertical location) of the finger (whether the key is pressed or not) is determined by whether the plane of light is crossed. Depending upon the particular angles and resolution required, this method may be implemented with one or more light sensors or cameras.

Binocular disparity is the general case of triangulation where all image points from each light sensor or camera need to be associated. Once associated, the corresponding location where the point resides on each sensor is compared. Mathematically, the distance can then be calculated trigonometrically using the difference of these locations. Practically, this method is difficult due to complex problem of associating image points. Often salient references are used instead, for example, defined reference points, corners, edges, etc. By definition, this requires two sensors (or two regions of a single sensor).

Rangefinding is the method of determining the distance of an object from a sensor. Traditionally there are two methods used. The first uses focus. A lens is adjusted while the image is tested for sharpness. The second method uses “time of flight” of the light as it is reflected from the object back to the sensor. The relationship is distance=½ (speed of light×time). The results from both of these techniques can result in a 3 dimensional map of the area of interest and therefore indicate when and which key is being pressed. Generally, these methods use a single sensor.

A new generation of hardware (and software implementations) are starting to be used for difficult to process operations. In particular, fuzzy logic is a technique where information (in this case, images) can be compared either directly or using statistically inferred correlations. For example, this might be used to implement binocular disparity by continuously comparing selected areas of the images against one another. When the resulting comparisons reach a peak value, the distance is determined. Related techniques include: autocorrelation, artificial intelligence and neural networks.

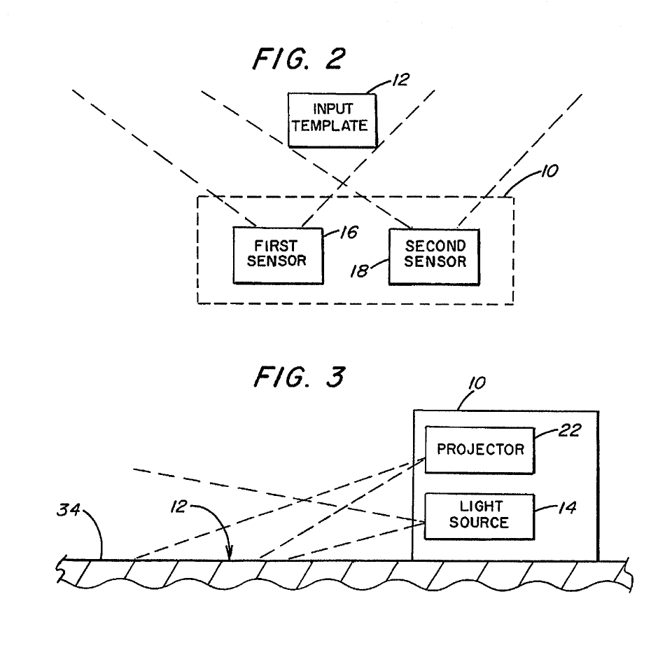

FIG. 2 is a top plan schematic view of the input device 10 illustrating the orientation of the first and second sensors 16, 18. In contrast to some prior art devices, the sensors 16, 18 in the present invention may be located remote from the area to be sensed, and may be facing in generally the same direction. Because the first and second sensors 16, 18 may be located remote from the area to be sensed, the input device 10 may be a small, compact device, which is ideal in applications such as personal organizers and laptop computers. For example, the present invention may be utilized in a laptop computer which :is significantly smaller than a keyboard, but which provides the user with a full size keyboard and mouse.

FIG. 3 is a schematic representation of the projector 22 and the light source 14 within an input device 10 constructed in accordance with the present invention. The input device 10 may be placed on a solid surface 34. The projector 22 may be placed high in the input device 10 so as to increase the angle at which the projector projects the input template 12 onto the surface 34. The light source 14 may be placed low in the input device 10 :so as to provide light adjacent to the input template 12 near the surface 34, and also to reduce “washout” of the projected input template 12 by reducing the amount of light incident on the surface 34.

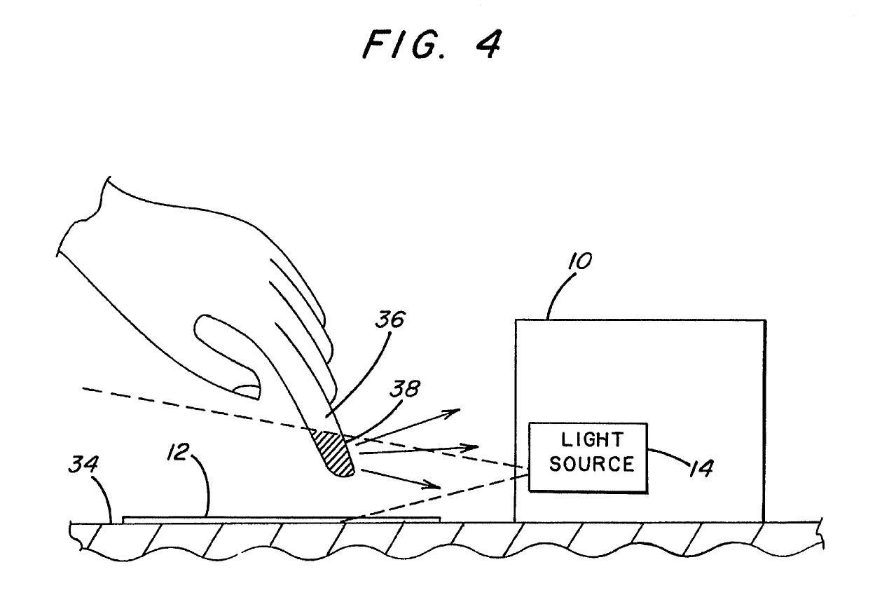

FIG. 4 is a perspective view of an input device 10 sensing input from a user's finger 36. A portion 38 of the user's finger 36 is illuminated by the light source 14 as the user's finger 36 approaches the input template 12. Light is reflected from the illuminated portion 38 of the user's finger 36 and is sensed by the first and second light sensors 16, 18 (illustrated in FIGS. 1 and 2). The light sensors 16, 18 (illustrated in FIGS. 1 and 2) are positioned to sense light at an acute angle with respect to the input template 12. The precise angle of the light from the user's finger 36 depends on the location of the first and second light sensors 16, 18 (illustrated in FIGS. 1 and 2) in the input device 10 and the distance of the input device 10 from the user's finger 36.

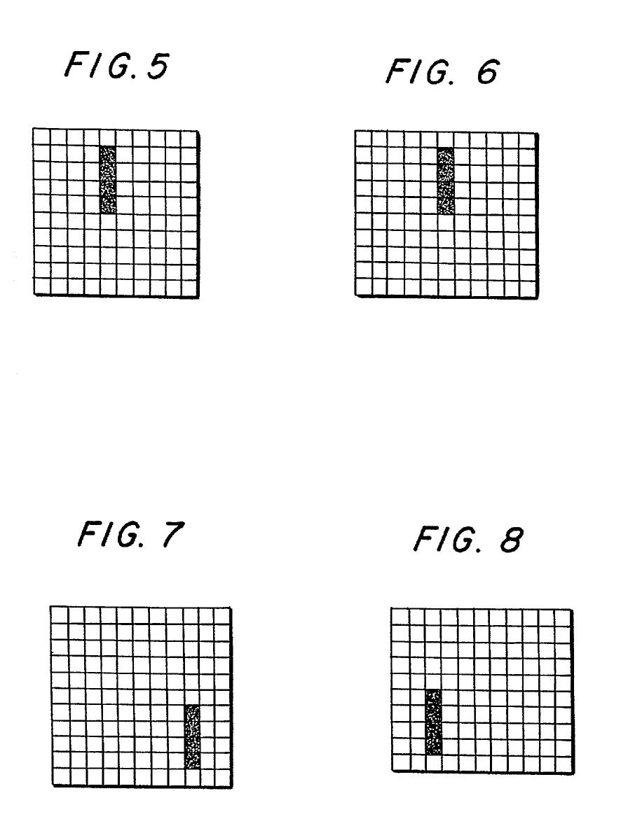

FIGS. 5 and 6 are graphical representations of light sensed by two two-dimensional matrix type sensors, such as may be used for first and second sensors 16, 18. A two-dimensional matrix type sensor is a type of light sensor used in video cameras and may be graphically represented as a two-dimensional grid of light sensors. Light sensed by the two-dimensional matrix sensor may be represented as a two-dimensional grid of pixels. The pixels darkened in FIGS. 5 and 6 represent the reflected light from the user's finger 36 illustrated in FIG. 4 and sensed by the first and second sensors 16, 18, respectively. The position of the user's finger 36 may be determined by applying binocular disparity techniques and/or triangulation techniques to the data from the first and second light sensors 16, 18. The relative left and right position of the user's finger 36 may be determined from the location of the sensed light in the pixel matrix. For example, if the object appears on the left side of the sensors 16, 18, then the object is to the left of the sensors 16, 18. If the object is sensed on the right side of the sensors 16, then the object is to the right. The distance of the user's finger 36 may be determined from differences in the images sensed by the sensors. For example, the farther the user's finger 36 is from the sensors, the more similar the images from the first and second light sensors 16, 18 will become. In contrast, as the user's finger 36 approaches the first and second sensors 16, 18, the images will become more and more dissimilar. For example, if the user's finger 36 is close to the first and second sensors 16, 18 and is generally near the center of the input template 12, one image will appear on the right side of one sensor and a different image will appear on the left side of the other sensor, as illustrated in FIGS. 7 and 8, respectively.

The input device 10 may determine when a user intends to select an item from the input template 12, as distinguished from when a user does not intend to make a selection, by the distance between the user's finger 36 and the input template 12. For example, the input device 10 may conclude that a user desires to select an item below the user's finger when the user's finger 36 is less than one inch from the input template 12. The input device 10 may be calibrated to determine distance between a user's finger 36 and the input template 12.

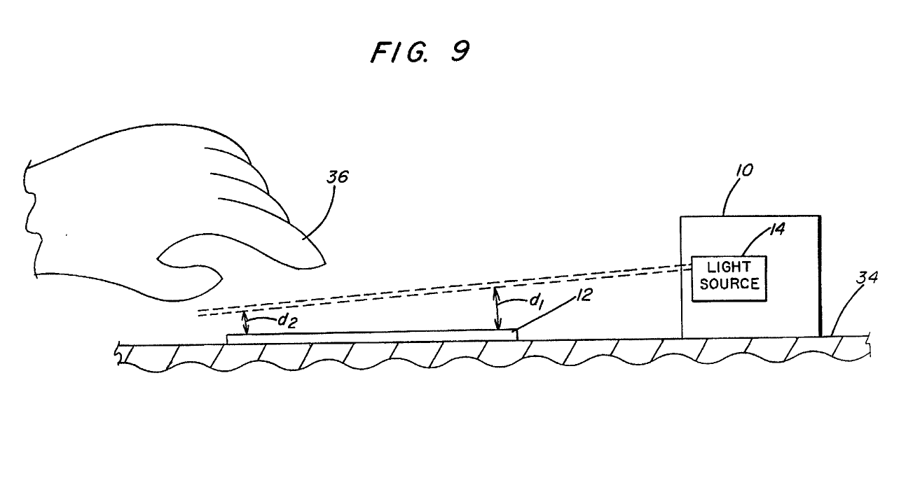

FIG. 9 is a combination side plan view and block diagram illustrating another embodiment of the present invention wherein the light source 14 produces a plane of light adjacent to the input template 12. In that embodiment, the plane of light defines a distance above the input template 12 where an object must be placed to select an item on the input template 12. That is because if the user's finger 36 is above the plane of light, the finger 36 will not reflect light back towards the first and second sensors 16, 18. In contrast, once the finger 36 breaks the plane of light, light will be reflected back to the light sensors 16, 18.

The light source 14 may be positioned so that the plane of light is sloped and its height is not constant above the input template 12. As illustrated in FIG. 9, the plane of light may be one distanced, above the template 12 at a point near the light source 14, and the plane of light may be another lesser distanced above the input template 12 away from the light source 14. The converse, of course, may also be implemented. Such non-uniform height of the plane of light may be used to facilitate sensing distance. For example, if the user's finger 36 is close to the light source 14, it will reflect light towards the top of it two-dimensional matrix type sensor. Conversely, if the user's finger 36 is far from the light source 14, it will reflect light towards the bottom of a two-dimensional matrix type sensor.

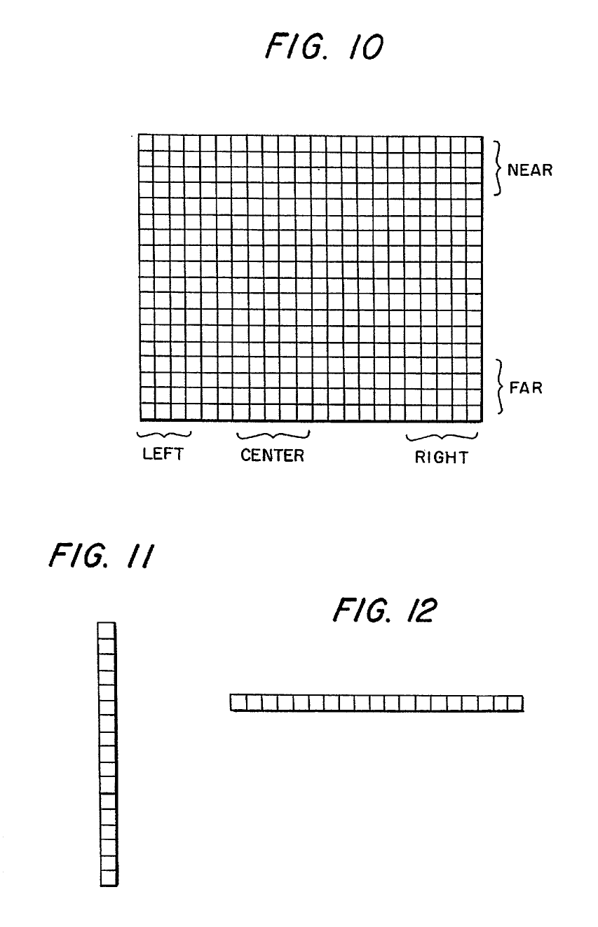

FIG. 10 is a graphical representation of a two-dimensional matrix type sensor illustrating how an image from a singe two-dimensional matrix type sensor may be used to determine position of an object adjacent to an input template. The position of an object may be determined from the portion of the two-dimensional matrix type sensor that detects the reflected light. For example, as with the embodiments described hereinabove, the direction of the object relative to the sensor may be determined from the horizontal position of light reflected from the object. For example, an object located to the left of the sensor will reflect light towards the left side of the sensor. An object located to the right of the sensor will reflect light towards the right side of the sensor. The distance from the sensor to the object may be determined by the vertical position of light reflected from the object. For example, in the embodiment illustrated in FIG. 9, an object near the sensor will result in light being reflected towards the top of the sensor. Conversely, an object farther away from the sensor will result in light being reflected closer to the bottom of the sensor. The slope of the plane of light and the resolution of the sensor will effect the depth sensitivity of the input device 10. Of course, if the slope of the plane of light illustrated in FIG. 9 is inverted, the depth perception of the sensor will be reversed.

FIGS. 11 and 12 illustrate one-dimensional array type sensors that maybe used in place of the two-dimensional matrix type sensor illustrated in FIG. 10. One-dimensional array type sensors are similar to two-dimensional matrix type sensors, except that they sense light in only one dimension. As a result, a one-dimensional array type sensor may be used to determine horizontal position of sensed light, but not vertical position of the sensed light. A pair of one-dimensional array type sensors may be oriented perpendicular to each other, so that, collectively, they may be used to determine a position of an object, such as a user's finger 36, in a similar manner to that described with respect to FIG. 10. For example, FIG. 11 illustrates a vertically oriented one-dimensional array type: sensor that may be used to determine the depth component of the position of the user's finger 36. FIG. 12 illustrates a horizontally oriented one-dimensional sensor that may be used to determine the left and right position of the user's finger 36.

The present invention may also include a calibration method as described hereinbelow. The calibration method may be used, for example, when a physical template, such as a paper or plastic image of an input device, is used. In such embodiment, the input device 10 may prompt the user for sample input. For example, in a case of a keyboard input template 12, the input device 10 may prompt the user to type several keys. The input sensed by the input device 10 is used to determine the location of the input template 12. For example, the input device 10 may prompt the user to type the words “the quick brown fox” in order to determine where the user has placed the input template 12. Alternatively, in the case of a pointer, such as a mouse, the input device 10 may prompt the user to indicate the boundaries of the pointer's range of motion. From that information, the input device 10 may normalize input from the input template 12.

In an alternative embodiment, the input device 10 may omit an input template 12. For example, a good typist may not need an image of a keyboard to enter data. In such a case, an input device 10 may prompt a user for sample input to determine where an input template 12 would be located if the user were utilizing an input template 12. Furthermore for simple input templates, such as an input template 12 having only a small number of inputs, an input template 12 may not be needed by any user. For example, an input template 12 having only two inputs can, under most circumstances, be reliably used by the user without an input template. In that example, one input may be selected by the user's finger 36 placed generally to the left side of the input device 10, while the other of the inputs may be selected by the user's finger 36 placed generally to the right side of the input device 10. If the input template 12 is eliminated, the reference plane 22 still exists. For example, one or more light sensors 16, 18 are positioned to sense light reflected at an acute angle with respect to the reference plane 22, even if the user is not using an input template 12.

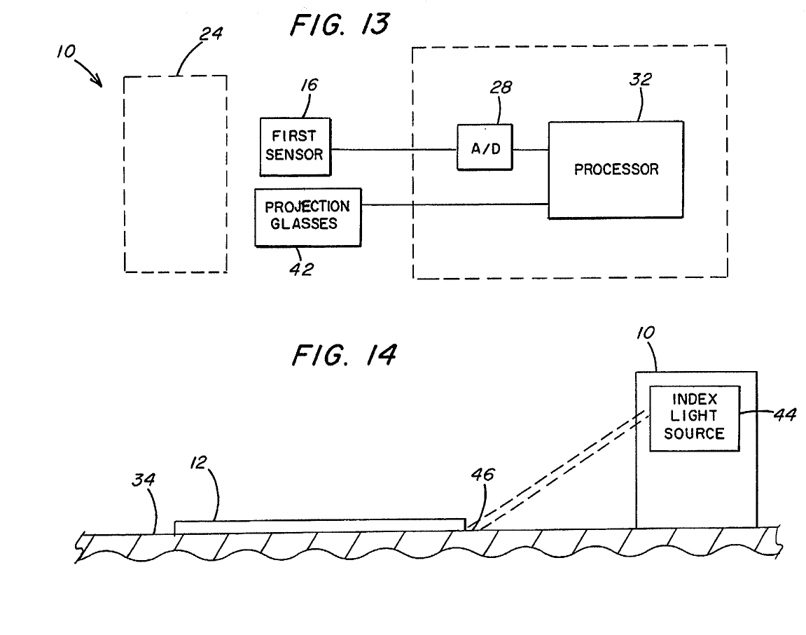

FIG. 13 is a block diagram illustrating an alternative embodiment of the present invention including projection glasses 42, such as may be used in virtual reality applications, to provide the user with an image of an input template 12. That embodiment eliminates the input template 12. The glasses 42 may be controlled by the processor 32. The glasses 42 may be position sensitive so that the processor 32 knows where and at what angle the glasses 42 are, thereby allowing the image created by the glasses 42 to appear to remain in one place relative to the user, even when the user's head moves. The glasses 42 may allow the user to see the surrounding reality as well as an image of an input template 12. In that embodiment, the input template 12 may remain in the same location in the user's field of vision, even when the user's head moves. Alternatively, if the glasses 42 are position sensitive, the input template 12 may remain in one location in the reality, such as on a desktop, when the user's head moves. The embodiment illustrated in FIG. 13 uses only one sensor 16 and no light source 14 or projector 22, although as described hereinabove, more sensors, a light source 14, and a projector 22 may be used.

FIG. 14 illustrates an alternative embodiment wherein an index light source 44 is provided. The index light source 44 is used to provide one or more index marks 46 on the surface 34. The index marks 46 may be used by a user to properly align a physical input template 12. In that embodiment, there may be no need for a calibration step to determine the precise location of the physical input template 12.

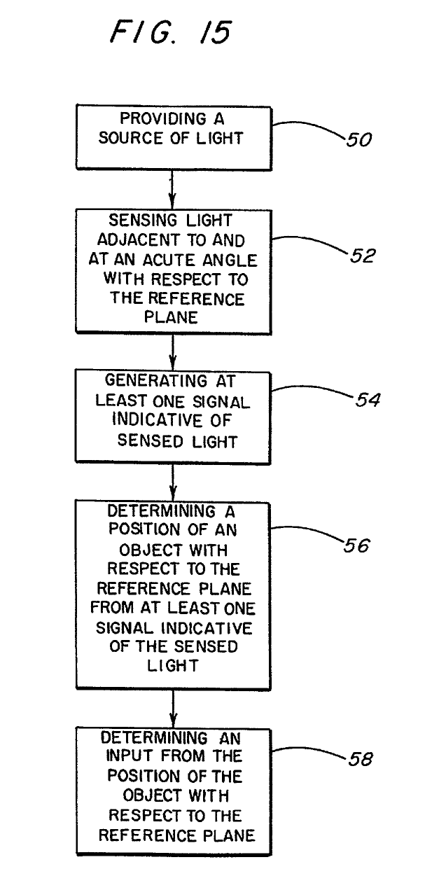

FIG. 15 is a block diagram illustrating a method of detecting an input with respect to a reference plane. The method includes providing a source of light 50, sensing light at an acute angle with respect to the reference plane 52, generating at least one signal indicative of sensed light 54, determining a position of an object with respect to the reference plane from the at least one signal indicative of the sensed light 56, and determining an input from the position of the object with respect to the reference plane 58. The method may include providing an input template in the reference plane, as in the description of the device provided hereinabove.

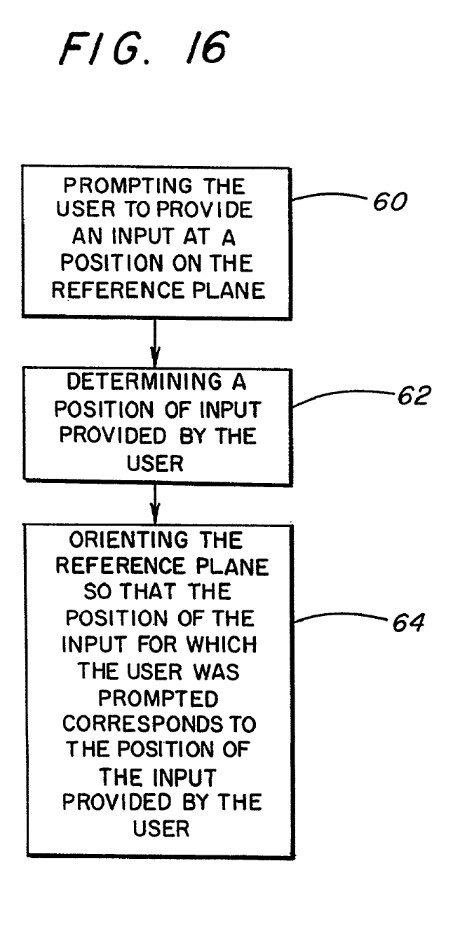

FIG. 16 is a block diagram illustrating a method of calibrating the input device. The method includes prompting the user to provide input at a position on the reference plane 60, determining a position fix the input provided by the user 62, and orienting the reference plane so that the position of the input for which the user was prompted corresponds to the position of the input provided by the user 64. An input template may be used by placing it in the reference plane and performing the calibration method. Regardless of whether 15 an input template is used, the reference plane is defined as an input device. The reference plane may be defined as any of many input devices, such as a keyboard or a pointer. For example, if the reference plane is defined as a keyboard, the calibration method may include prompting the user to enter a character on the keyboard and orienting the reference plane so that the position of the character for which the user was prompted corresponds to the position of the input provided by the user. The calibration method may be performed with more than one; input from a user, so that the method includes prompting the user for a plurality of inputs (each having a position on the reference plane), determining a position for each input provided by the user, and orienting the reference plane so that the position of each of the inputs for which the user was prompted corresponds to the positions of each of the inputs provided by the user. Determining a position of one or more inputs provided by the user may be accomplished in the same manner that an input is determined in normal operation. In other words, determining may include providing a source of light, sensing light at an acute angle with respect to the reference plane, generating at least one signal indicative of sensed light, and determining a position of an object with respect to the reference plane from the at least one signal indicative of the sensed light.

Those of ordinary skill in the art will recognize that many modifications and variations of the present invention may be implemented. For example, the invention was described with respect to a user's finger 36 being used to select items on the input template 12, although other things, such as pencils and pens, may be used to select items on the input template 12. As another example, the light source 14 may be eliminated. Depth of an object may be determined by the object's size. An object that is close to the sensor will appear larger than an object that is farther away. Calibration of the input device 10, such as described hereinabove, may be used to determine the size of the object at various locations. For example, prior to inputting data, the user may be prompted to select an input near the top of the input template 12, and then to select an item near the body of the input template 12. From that information, the input device 10 may interpolate for positions in between. The foregoing description and the following claims are intended to cover all such modifications and variations.

I claim:

1. A system for detection of an object in an area irradiated by waves in an invisible spectral range, the system comprising:
a projector configured such that a video image is projectable onto the area;
a device for emitting waves in the invisible spectral range configured such that the area is substantially illuminated;
a reception device configured such that the reception device registers the irradiated area, the reception device being specifically balanced for an invisible spectral range corresponding to the waves; and
a computer configured with a recognition algorithm, whereby the object irradiated by the emitted waves is detected using the recognition algorithm.

2. The system according to claim 1, wherein the device for emitting waves in the invisible spectral range has at least one infrared light source, and wherein the reception device is at least one camera.

3. The system according to claim 2, wherein the infrared light source is one of an infrared light-emitting diode and an incandescent bulb with an infrared filter.

4. The system according to claim 3, wherein the camera has a filter that is transmissive only for infrared light.

5. The system according to claim 4, wherein the filter of the camera is only transmissive for a spectral range of the infrared light-emitting diode or the incandescent bulb with an infrared filter.

6. The system according to claim 1, wherein the area is transilluminated from below with infrared light, and the projection surface is implemented reflective in a visible spectral range and is implemented transmissive in the infrared spectral range.

7. The system according to, claim 1, wherein the device for emitting waves in the invisible spectral range has at least one device for emission of ultraviolet radiation, and wherein the reception device is at least one receiver for ultraviolet radiation.

8. The system according to claim 1, wherein the device for emitting and the reception device lie on an optical axis.

9. A method for detecting an object in an area, the method comprising the steps of:
generating a video image having at least one field with a function available thereto in the area by a computer, the video image being projected onto a predetermined area;
moving the object into the predetermined area;
irradiating the area by waves whose wavelength lies in the invisible spectral range in order to detect the object;
using a reception device specifically balanced for the invisible spectral range corresponding to the waves to detect the object; and
triggering a function of a field by the object in that the object dwells in the field for a predetermined time.

10. The method according to claim 9, further comprising the step of moving a mouse pointer associated with the object across the projected area by moving a finger of a user.

11. The method according to claim 9, further comprising the step of implementing the control characteristic as one of a finger of a user, a hand of a user or a pointer.

12. A non-contact device for the translating the movement of an object into data comprising:
one or more light sources;
one or more light sensors, aligned to sense light reflected from said object, as said object is illuminated by said one or more light sources; and
a circuit, for calculating the relative position of said object with respect to one or more reference points, based on said sensed, reflected light.

13. The device of claim 12 further comprising a template of a data input device.

14. The device of claim 13 wherein said input template is a physical template.

15. The device of claim 12 further comprising:
a projector;
wherein said input template is a projected image.

16. The device of claim 12 wherein said input template is a holographic image.

17. The device of claim 12 wherein said input template is a spherical reflection.

18. The device of claim 12 wherein said one or more light sources provide light of a type selected from a group comprising visible light, coherent light, ultraviolet light, and infrared light.

19. The device of claim 12 wherein said circuit includes a processor for applying an algorithm for calculating said position of said object.

20. The device of claim 19 wherein said algorithm utilizes triangulation.

21. The device of claim 19 wherein said algorithm utilizes binocular disparity.

22. The device of claim 19 wherein said algorithm utilizes mathematical rangefinding.

23. The device of claim 20 wherein said algorithm utilizes fuzzy logic.

24. The device of claim 21 wherein said algorithm utilizes fuzzy logic.

25. The device of claim 22 wherein said algorithm utilizes fuzzy logic.

26. The device of claim 12 wherein said one or more light sensors are two dimensional matrix type light sensors.

27. The device of claim 12 wherein said one or more light sensors are one dimensional array type light sensors.

28. The device of claim 12 further comprising an interface for connecting said device to a computer, such that said data representing the position of said object can be transferred from said device to said computer via said interface.

29. The device of claim 28 wherein said interface is hard wired.

30. The device of claim 28 wherein said interface is wireless/

31. The device of claim 30 wherein said wireless interface is selected from a group comprising infrared, RF and microwave.
